(19) United States
(12) Patent Application Publication
(10) Pub. No.: US 2010/0190009 A1
(43) Pub. Date: Jul. 29, 2010

(54) ABRASION-RESISTANT ANTISEPTIC TOUCH PANEL AND FABRICATING METHOD THEREOF

(76) Inventors: Chia-Chih CHANG, Taipei County (TW); Chia-Yen Li, Taipei County (TW); Yu-Hui Huang, Taipei County (TW)

Correspondence Address: Muncy, Geissler, Olds & Lowe, PLLC, 4000 Legato Road, Suite 310, FAIRFAX, VA, 22033, US

(21) Appl. No.: 12/360,986

(22) Filed: Jan. 28, 2009

(51) Int. Cl. B05D 3/02; B32B 27/36; B32B 17/10

(52) U.S. Cl. 428/412; 427/385.5; 428/428; 428/446

(57) ABSTRACT

An abrasion-resistant antiseptic touch panel and a fabricating method thereof aim to form an antiseptic layer on the touch panel that contains a nano-antiseptic material in a polymer formed according to a Formula (I) as follow:

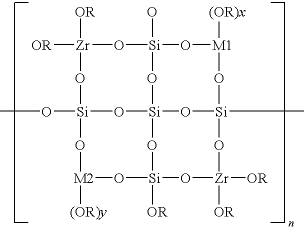

The touch panel thus formed can provide persistent, abrasion-resistant and safer antiseptic effect.

### FIELD OF THE INVENTION

The present invention relates to touch panels and a fabricating method thereof, and particularly to an abrasion-resistant antiseptic touch panel and a fabricating method thereof.

### BACKGROUND OF THE INVENTION

Touch panel is a new type of input interface allowing users to enter signals or data into a computer directly by touching a display device. Compared with the traditional input devices such as mice or keyboards, the touch panel transforms areas touched by user's fingers or a stylus to electric signals for signal input. Hence it is much more user-friendly. Because of improved convenience and practicality, touch panels have been widely used in various products, including small-size portable electronic products and middle-size or large-size industrial computers. Take a general resistance touch panel for instance, it includes a first substrate touchable by users and a second substrate. The first and second substrates have corresponding surfaces deposited with an Indium Tin Oxide (ITO) film. The first and second substrates also are interposed by an insulation spacer. When the first substrate is depressed by a user, the first and second substrates are in contact with each other and a signal corresponding to the depressed location is generated. Whatever the applications, the touch panels perform input through “direct touch”. For touch panels of electronic devices installed in public places, they are frequently touched by many people and become hotbeds of bacteria.

To solve the abovementioned problem, electronic manufacturers have applied antiseptic materials to the field of touch panels. Antiseptic materials include: antibiotics, inorganic antiseptic agents, organic antiseptic agents, etc., which are usually slow gradually released to kill bacteria. For example, a R.O.C. patent No.I272110 disclosed a touch panel with an antiseptic layer and a method for fabricating the same, wherein metallic nanoparticles with a diameter of 1-100 nm are uniformly applied onto the surface of a touch panel to form an antiseptic layer. The metallic nanoparticles may be gold nanoparticles, silver nanoparticles, copper nanoparticles, zinc nanoparticles, platinum nanoparticles or a compound thereof. These metallic nanoparticles have biochemical activity and can penetrate the cell walls of bacteria to denature the enzymes inside the cells and kill the bacteria. The working time of the slow gradual-release antiseptic agents can be prolonged via adjusting the concentration thereof or via decreasing the releasing speed thereof. However, the antiseptic agents will be exhausted after a period of time, and then they have to be coated again. Moreover, the metallic nanoparticles do not form a stable bond with the touch panels and are easily attached to a contact object. This creates a toxic issue to human being or the environment, and also generates pollution.

Another example of antiseptic material used on the touch panels is disclosed in U.S. Pat. No. 6,504,583 which utilizes a derivative of alkyl quaternary ammonium salts as an antiseptic agent. Alkyl quaternary ammonium salts have positive charges. When it is in contact with the negative-charged bacterium cell surfaces, the electric balance of the bacterium cell membranes will be destroyed. Thus, the cell organs neighboring the surfaces of the cell membranes cannot perform metabolism, or even the cytoplasm leaks out because of breaking of the unstable cell membranes. In comparison with the abovementioned metallic antiseptic agents, the alkyl quaternary ammonium salts do not directly kill bacteria but function as a catalyst to destroy the charge balance of cells. Therefore, the alkyl quaternary ammonium salts will not be consumed but will maintain their concentrations. However, the antiseptic agent used by the U.S. Pat. No. 6,504,583 has a limited effect and an inferior adhesion. During the service period, this type of antiseptic agents is likely to be worn away or peeled off. Thus, the effect of this type of antiseptic agents will be attenuated with increasing service time.

### SUMMARY OF THE INVENTION

The primary objective of the present invention is to provide a touch panel with persistent antiseptic and abrasion-resistant effects to reduce wearing or peeling off of antiseptic agents such as alkyl quaternary ammonium salt during service, or prevent the problem of easy contamination to users happened to the conventional inorganic antiseptic agents or environmental pollution. To achieve the abovementioned objective, the present invention proposes an abrasion-resistant antiseptic touch panel comprising: a touch panel substrate to be touch-operated by users and an antiseptic layer coated on the surface of the touch panel substrate. The antiseptic layer contains nano-antiseptic material formed like a polymer by Formula (I) as follow:

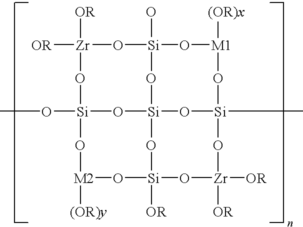

where R is halogen, hydrogen, alkyl, alkoxy, hydroxyl, alkenyl, alkynyl, acyl, aryl, carboxycarbonyl, alkoxycarbonyl or aryloxycarbonyl. M1 and M2 are same or different metals, and may be Zirconium (Zr), Copper (Cu), Titanium (Ti), Gold (Au), Platinum (Pt) or Zinc (Zn). X and y are an integer between 0 and 2, and n is an integer between 1 and 1000.

The nano-antiseptic material may also be a polymer formed by Formula (II) below:

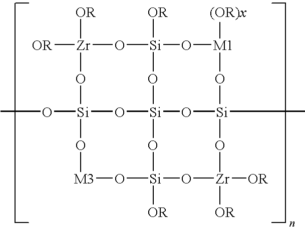

where R is halogen, hydrogen, alkyl, alkoxy, hydroxyl, alkenyl, alkynyl, acyl, aryl, carboxycarbonyl, alkoxycarbonyl or aryloxycarbonyl. M1 is metal of Zr, Cu, Ti, Au, Pt or Zn, and M3 is Silver (Ag), Au or Cu. X is an integer between 0 and 2, and n is an integer between 1 and 1000.

Another objective of the invention is to provide a simplified fabricating method to produce the aforementioned abrasion-resistant antiseptic touch panel to allow the abrasion-resistant antiseptic material to be firmly adhered to the touch panel. To achieve the objective set forth above, the method according to the invention further provides a method to fabricate the abrasion-resistant antiseptic touch panel with the polymers formed by the Formula (I) or (II) mentioned above. The method includes the steps as follow:

a). step of forming antiseptic material: producing a nano-antiseptic material with a polymer of Formula (I) or (II);

b). step of coating the antiseptic material: coating the nano-antiseptic material with the polymer of Formula (I) or (II) on the touch surface of a touch panel substrate; and

c). step of adhering to the substrate: adhering the nano-antiseptic material with the polymer of Formula (I) or (II) coated on the touch surface firmly to the touch panel substrate.

Wherein, the step of forming antiseptic material further includes another step of diluting the nano-antiseptic material to a concentration of 1%. The step of coating the antiseptic material includes employing a coating method of spraying, dipping, rolling, printing, spinning or hand brushing. The step of adhering to the substrate includes heating the touch panel substrate coated with the nano-antiseptic material in an environment at temperature between 100° C. and 800° C. for at least one minute, or disposing the touch panel substrate coated with the nano-antiseptic material in a room temperature environment for at least 10 hours.

Compared with the antiseptic agents used on the touch panels in the conventional techniques such as alkyl quaternary ammonium salts or inorganic antiseptic agents, the abrasion-resistant antiseptic touch panel of the invention provides enhanced abrasion resistance and persistent and more effective antiseptic effect. In addition, the antiseptic agent can be firmly adhered to the surface of the touch panel of the invention. Hence the problem of peeling off of the antiseptic agent that causes contamination to human bodies or environmental pollution can be prevented.

### DETAILED DESCRIPTION OF THE PREFERRED EMBODIMENTS

The present invention discloses an abrasion-resistant antiseptic touch panel comprising: a touch panel substrate, which is to be touch-operated by users, and an antiseptic layer coated on the surface of the touch panel. The touch panel substrate may be made from an organic material, such as polyethylene terephthalate (PET) or polycarbonate (PC), or an inorganic material, such as glass. However, the present invention does not limit the material of the substrate. The antiseptic layer contains nano-antiseptic material formed like a polymer by Formula (I) below:

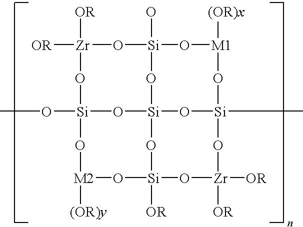

where R is halogen, hydrogen, alkyl, alkoxy, hydroxyl, alkenyl, alkynyl, acyl, aryl, carboxycarbonyl, alkoxycarbonyl or aryloxycarbonyl; or preferably —H, —OH, —OCH₃, —OC₂H₅, —CH₃, —CH═CH₂, —OC₂H₄OCH₃ or —C₃H₆COOC₂H₅ M1 and M2 are same or different metals, and may be Zr, Cu, Ti, Au, Pt or Zn. X and y are an integer between 0 and 2, and n is an integer between 1 and 1000.

The nano-antiseptic material may also be a polymer formed by Formula (II) below:

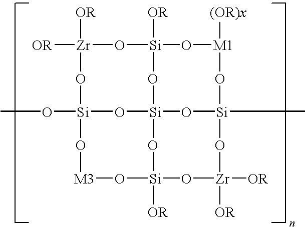

where R is halogen, hydrogen, alkyl, alkoxy, hydroxyl, alkenyl, alkynyl, acyl, aryl, carboxycarbonyl, alkoxycarbonyl or aryloxycarbonyl; or preferably —H, —OH, —OCH₃, —OC₂H₅, —CH₃, —CH═CH₂, —OC₂H₄OCH₃ or —C₃H₆COOC₂H₅ M1 is metal of Zr, Cu, Ti, Au, Pt or Zn, and M3 is Ag, Au or Cu. X is an integer between 0 and 2, and n is an integer between 1 and 1000.

The polymer formed by Formula (I) or (II) that contains the nano-antiseptic material mainly has a structure composed of silicon functional group (SiOₓ) and inorganic ions. Through interactions of non-covalent bonds among hydrogen bonds, Van der Waals force and coordinate bonds, superamoleculars are formed, thereby to cluster and form a stable sol-gel.

The silicon functional group SiOₓ is internally linked through Si—O—Si bonds to form a mesh type structure, thus has a greater surface area and a stronger adsorption characteristic to form a transparent layer which can be sintered at high temperature to become a glass-like substance equipped with characteristics of high abrasion-resistance and hardness. The silicon functional group SiOₓ and the touch panel substrate form a strong chemical covalent bond between them after the sinter process. Hence the antiseptic layer is less likely to separate from the touch panel substrate and has a stronger abrasion-resistant capability. As a result, the antiseptic effect can be maintained persistently without diminishing for a long period of services. In addition, the silicon functional group SiOₓ is formed at a nano-particle size and has a greater proportion of surface area against the volume. Due to surface bonding and electron conditions are different from the interior of the particles, and atom coordination on the surface is incomplete, surface active positions increase. Thus a high valence oxide with a strong reduction potential is formed. It provides a strong catalyzing capability for the oxygen in the surrounding water and air to form active oxygen ions (such as O₃) and hydrogen oxygen free radicals. The active oxygen ions have strong oxidation which can permeate into the bacteria or viruses to have the protein denaturation and to destroy bacteria enzyme, thus provide a powerful disinfecting effect. Such an antiseptic mechanism utilizes the strong reduction potential of the high valence oxide to generate atomic oxygen in the ambience, thus is innocuous to environments and human body.

The inorganic ions adsorb the negative-charged bacteria through Coulombic forces. After the bacteria of the size about 1 μm have contacted with the inorganic ions of the size about 30-40 nm, the ions penetrate their cell walls and enter the cells to couple with phospholipids and cholesterol in the bacteria cytoplasmic membrane to increase the permeability of the cytoplasmic membrane. And the cell membrane is shattered to debris at diameters smaller than 60 nm, while the outer layer of the bacteria generates induced negative charges and results in uneven charges on the outer layer. The inorganic ions destroy the internal electronic transmission system, metabolizing system and the balance of surface charges of substance transportation system. A reaction with —SH also takes place to congeal the protein and destroy the activity of the synthesized enzyme of the cells. Thereby the contacted bacteria or micros lose division and reproduction capability and perish. After the bacteria or microbes have lost their activity, the antiseptic capability is maintained intact and can continuously provide disinfecting function. Hence the antiseptic effect can be maintained persistently for a long period of time. Moreover, as human skin has an outer protection layer formed at a thickness between 1-2 mm, and is about 1000 times of the bacteria, and 100000 times greater than the inorganic antiseptic material, hence keratinocytes of human body do not suffer from any harmful effect. The antiseptic material of the invention provides disinfection only to micro ill-inflicting bacteria and is harmless to human body.

The present invention further provides a method to fabricate the abrasion-resistant antiseptic touch panel coated with the polymer formed by Formula (I) or (II) previously discussed. The method includes the steps as follow:

a). step of forming antiseptic material: producing a nano-antiseptic material with a polymer of Formula (I) or (II);

b). step of coating the antiseptic material: coating the nano-antiseptic material with the polymer of Formula (I) or (II) on the touch surface of a touch panel substrate; and

c). step of adhering to the substrate: adhering the nano-antiseptic material with the polymer of formula (I) or (II) coated on the touch surface firmly to the touch panel substrate.

Wherein, the step of forming antiseptic material further includes another step of diluting the nano-antiseptic material to a concentration of 1%.

The step of coating the antiseptic material includes adopts a coating method of spraying, dipping, rolling, printing, spinning or hand brushing. The step of adhering to the substrate includes heating the touch panel substrate coated with the nano-antiseptic material in an environment at temperature between 100° C. and 800° C. for at least one minute, or disposing the touch panel substrate coated with the nano-antiseptic material in a room temperature environment for at least 10 hours.

The embodiments of the method of the present invention, and the abrasion resistance and antiseptic effect thereof will be described in detail below.

### Embodiment I

This embodiment provides a fabrication process flow as follow: first, forming a nano-antiseptic material with a polymer of Formula (I) or (II) by synthesizing through a chemical colloid method via mechanical mixing to get homogenous colloid solution; next, coating the nano-antiseptic material on a deposited layer of a panel, or diluting the nano-antiseptic material before coating on the deposited layer of the panel. The nano-antiseptic material is through an alcohol-based organic solvent such as isopropanol, ethanol, ketone, ether or benzene, and the blended solution is mixed evenly through a mechanical mixer with blades, a spinbar or a roller rolling to become a homogeneous nano-antiseptic material solution. Coating on the deposited layer of the panel may adopt spraying, dipping, rolling, printing, spinning or hand brushing. Then the touch panel substrate coated with the nano-antiseptic material in the polymer of Formula (1) or (II) is heated in an environment at a temperature between 100° C. and 800° C. for at least one minute to make the polymer of Formula (I) or (II) to crystallize and form in a chemical structure to generate a covalent bonding reaction with the touch panel substrate, and also create antiseptic function. Therefore, the abrasion-resistant nano-antiseptic material is firmly adhered to the touch panel substrate. Finally the heated touch panel is cooled down to form an antiseptic layer.

### Embodiment II

Test of abrasion resistance for the abrasion-resistant antiseptic touch panel. This is done through a mechanical abrasion machine by sliding a weight of 1.5 Kg to and fro once on the surface of the touch panel with an abrasion-resistant antiseptic layer formed thereon containing the nano-antiseptic material in the polymer of Formula (I) or (II) as previously discussed. Then test and inspect panel resistance whether damage occurs.

For an ITO glass coated with the nano-antiseptic material in the polymer of Formula (I) or (II), acceptable abrasion test result should withstand at least 2000 times of to and for abrasion sliding.

### Embodiment III

Test of antiseptic effect of the antiseptic touch panel of the invention. This is performed by exposing to Escherichia coli of Gram positive bacteria. On an ITO glass and an untreated ITO glass at a size of 5 cm² and coated with the nano-antiseptic material in the polymer of Formula (I) or (II), respectively and evenly dispense the Escherichia coli with a number greater than 10⁵. Next, the ITO glass holding the Escherichia coli is respectively incubated in an environment of 35° C. for 24 hours. After the incubation is completed, cleansing with a sterile phosphate buffer (50 ml) to remove dead Escherichia coli, and the ITO glass is tested again for total number of survived Escherichia coli. If the survived Escherichia coli is less than 0.0001%, and the untreated ITO glass has more than 90% of the Escherichia coli survived, the ITO glass coated with the abrasion-resistant nano-antiseptic material in the polymer of Formula (I) or (II) has antiseptic effect greater than the untreated one by 10⁵ times.

### Embodiment IV

Prepare an ITO glass coated with the abrasion-resistant nano-antiseptic material in the polymer of Formula (I) or (II); next, dispose the ITO glass through a weathering test under high humidity (more than 200 hrs), high temperature (more than 100 hrs), low temperature (more than 100 hrs) and cold/hot impacts (repeatedly for more than forty times); then perform the antiseptic test depicted in Embodiment III. Test results shown that the ITO glass coated with the abrasion-resistant antiseptic material in the polymer of Formula (I) still maintains 99.99% of antiseptic effectiveness after the weathering test. Namely, the ITO glass coated with the abrasion-resistant nano-antiseptic material in the polymer of Formula (I) or (II) maintains 99.99% of antiseptic effectiveness after the weathering test under high temperature, low temperature, high humidity and cold/hot impacts. These test results indicate that the invention can provide weather resistant and persistent antiseptic function.

In conclusion, the present invention proposes an abrasion-resistant antiseptic touch panel, which adopts an abrasion-resistant nano-antiseptic material with polymer of Formula (I) or (II), and includes inorganic ions and silicon functional group to provide antiseptic function, and also forms a covalent bond between the silicon functional group and the touch panel substrate. Thus, the antiseptic touch panel of the present invention has a persistent antiseptic effect without diminishing even in a long service period. Therefore, the present invention indeed possesses novelty and non-obviousness and meets the conditions for a patent. Accordingly, the Inventor files the patent application for the present invention. It will be greatly appreciated that the patent is approved fast.

The present invention has been described in detail above. However, those described above are only the preferred embodiments to exemplify the present invention but not to limit the scope of the present invention. Any equivalent modification or variation according to the spirit of the present invention is to be also included within the scope of the present invention.

What is claimed is:

1. An abrasion-resistant antiseptic touch panel comprising:
a touch panel substrate, which is to be touch-operated by users; and
an antiseptic layer coated on the touch panel substrate and having a nano-antiseptic material contained in a polymer formed according to Formula (I) as follow: 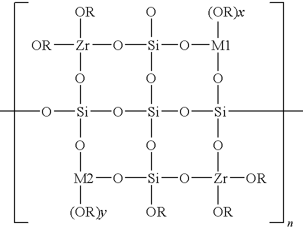
wherein R is selected from a group consisting of halogen, hydrogen, alkyl, alkoxy, hydroxyl, alkenyl, alkynyl, acyl, aryl, carboxycarbonyl, alkoxycarbonyl and aryloxycarbonyl, M1 and M2 are same or different metals selected from a group consisting of Zirconium (Zr), Copper (Cu), Titanium (Ti), Gold (Au), Platinum (Pt) and Zinc (Zn), X and y are an integer between 0 and 2, and n is an integer between 1 and 1000.

2. The abrasion-resistant antiseptic touch panel according to claim 1, wherein the R in the polymer of Formula (I) is selected from a group consisting of —H, —OH, —OCH₃, —OC₂H₅, —CH₃, —CH═CH₂, —OC₂H₄OCH₃ and —C₃H₆COOC₂H₅.

3. A method for fabricating an abrasion-resistant antiseptic touch panel with the polymer of Formula (I) in claim 1 comprising steps:
forming the nano-antiseptic material with the polymer of Formula (I);
coating the nano-antiseptic material with the polymer of Formula (I) on the touch panel substrate; and
adhering the nano-antiseptic material with the polymer of Formula (I) firmly to the touch panel substrate.

4. The method for fabricating the abrasion-resistant antiseptic touch panel according to claim 3, wherein said forming the nano-antiseptic material further includes another step of diluting the nano-antiseptic material.

5. The method for fabricating the abrasion-resistant antiseptic touch panel according to claim 4, wherein the nano-antiseptic material is diluted to a concentration of 1%.

6. The method for fabricating the abrasion-resistant antiseptic touch panel according to claim 3, wherein said coating the nano-antiseptic material selectively includes spraying, dipping, rolling, spinning, printing or hand-brushing.

7. The method for fabricating the abrasion-resistant antiseptic touch panel according to claim 3, wherein said adhering the nano-antiseptic material is realized via heating the touch panel substrate coated with the nano-antiseptic material in an environment at a temperature between 100° C. and 800° C. for at least one minute.

8. The method for fabricating the abrasion-resistant antiseptic touch panel according to claim 3, wherein said adhering the nano-antiseptic material is realized via placing the touch panel substrate coated with the nano-antiseptic material at an ambient temperature for at least 10 hours.

9. An abrasion-resistant antiseptic touch panel comprising:
a touch panel substrate, which is to be touch-operated by users; and
an antiseptic layer coated on the touch panel substrate and having a nano-antiseptic material contained in a polymer formed according to Formula (II) as follow: 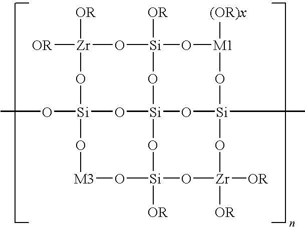
wherein R is selected from a group consisting of halogen, hydrogen, alkyl, alkoxy, hydroxyl, alkenyl, alkynyl, acyl, aryl, carboxycarbonyl, alkoxycarbonyl and aryloxycarbonyl, M1 is selected from a group consisting of Zr, Cu, Ti, Au, Pt and Zn, M3 is selected from a group consisting Ag, Au and Cu, x is an integer between 0 and 2, and n is an integer between 1 and 1000.

10. The abrasion-resistant antiseptic touch panel according to claim 9, wherein the R in the polymer of Formula (II) is selected from a group consisting of —H, —OH, —OCH₃, —OC₂H₅, —CH₃, —CH═CH₂, —OC₂H₄OCH₃ and —C₃H₆COOC₂H₅.

11. A method for fabricating an abrasion-resistant antiseptic touch panel with the polymer of Formula (II) in claim 9 comprising steps:
forming the nano-antiseptic material with the polymer of Formula (II);
coating the nano-antiseptic material with the polymer of Formula (II) on the touch panel substrate; and
adhering the nano-antiseptic material with the polymer of Formula (II) firmly to the touch panel substrate.

12. The method for fabricating the abrasion-resistant antiseptic touch panel according to claim 11, wherein said forming the nano-antiseptic material further includes another step of diluting the nano-antiseptic material.

13. The method for fabricating the abrasion-resistant antiseptic touch panel according to claim 12, wherein the nano-antiseptic material is diluted to a concentration of 1%.

14. The method for fabricating the abrasion-resistant antiseptic touch panel according to claim 11, wherein said coating the nano-antiseptic material selectively includes spraying, dipping, rolling, spinning, printing or hand-brushing.

15. The method for fabricating the abrasion-resistant antiseptic touch panel according to claim 11, wherein said adhering the nano-antiseptic material is realized via heating the touch panel substrate coated with the nano-antiseptic material in an environment at a temperature between 100° C. and 800° C. for at least one minute.

16. The method for fabricating the abrasion-resistant antiseptic touch panel according to claim 11, wherein said adhering the nano-antiseptic material is realized via placing the touch panel substrate coated with the nano-antiseptic material at an ambient temperature for at least 10 hours.
